(19) United States
(12) Patent Application Publication
(10) Pub. No.: US 2026/0140621 A1
(43) Pub. Date: May 21, 2026

(54) ELECTRONIC DEVICE AND OPERATING METHOD OF THE SAME

(71) Applicant: Samsung Electronics Co., Ltd., Suwon-si (KR)

(72) Inventors: Hyeryoung CHOI, Suwon-si (KR); Changwoo LEE, Suwon-si (KR); Dongyoon KIM, Suwon-si (KR)

(73) Assignee: Samsung Electronics Co., Ltd., Suwon-si (KR)

(21) Appl. No.: 19/322,200

(22) Filed: Sep. 8, 2025

Related U.S. Application Data
(63) Continuation of application No. PCT/KR2025/011574, filed on Aug. 4, 2025.

(30) Foreign Application Priority Data
Nov. 20, 2024 (KR) 10-2024-0166605

(51) Int. Cl. G06F 3/04886; G06F 3/01; G06F 3/04817; G06F 3/16

(52) U.S. Cl. CPC G06F 3/04886; G06F 3/017; G06F 3/04817; G06F 3/167; G06F 2203/04803

(57) ABSTRACT

Provided is an operating method of an electronic device, the method including receiving a user input of designating a region on a display, and controlling the region to operate in a mirror mode or a display mode based on at least one of a location of a region designated based on the user input, a size of the region, an operation mode of the display, or a surrounding environment of the display.

### CROSS-REFERENCE TO RELATED APPLICATION

This application is a continuation application, under 35 USC § 111(a), of International Application No. PCT/KR 2025/011574, filed on Aug. 4, 2025, which claims priority to Korean Patent Application No. 10-2024-0166605, filed on Nov. 20, 2024, in the Korean Intellectual Property Office, the disclosure of which is incorporated by reference herein in its entirety.

### TECHNICAL FIELD

The disclosure relates to an electronic device and an operating method of the electronic device. More particularly, the disclosure relates to an electronic device for setting a designated region to a mirror mode or a display mode, based on the characteristics of a display region designated by a user, and an operating method of the electronic device.

### BACKGROUND ART

When a micro-light-emitting diode (micro-LED) mirror is applied to a display, an LED may be controlled on a pixel-by-pixel basis, and thus, the entirety or a portion of the display may be used as a mirror.

In this case, determinations as to at what point the display is set and used as a mirror mode and at what point the display is set and used as a display mode are needed.

Furthermore, when such a setting change is performed automatically via prediction of a user's intention instead of being manually performed according to a user input, the user is allowed to conveniently change the display mode so that usability of a display can be improved.

### DISCLOSURE

### Technical Solution

According to an embodiment of the disclosure, an electronic device may include at least one processor including processing circuitry; and a memory configured to store one or more instructions executable by the at least one processor, wherein the at least one processor executes the one or more instructions, individually or collectively, to cause the electronic device to: receive a user input of designating a region on a display, identify the region within the display for control, and control the region to operate in a mirror mode or a display mode based on at least one of a location of the region, a size of the region, an operation mode of the display, and a surrounding environment of the display.

According to an embodiment of the disclosure, a method of operating an electronic device may include receiving a user input of designating a region on a display; identifying the region within the display for control; and controlling the region to operate in a mirror mode or a display mode based on at least one of a location of the region, a size of the region, an operation mode of the display, and a surrounding environment of the display.

An electronic device according to an embodiment of the disclosure may include at least one processor including processing circuitry.

An electronic device according to an embodiment of the disclosure may include memory that stores one or more instructions.

The one or more instructions, when executed by the at least one processor individually or collectively, may cause the electronic device to receive a user input of designating a region on a display.

The one or more instructions, when executed by the at least one processor individually or collectively, may cause the electronic device to control the region to operate in a mirror mode or a display mode, based on at least one of a location of a region designated based on the user input, a size of the region, an operation mode of the display, or a surrounding environment of the display.

An operating method of an electronic device, according to an embodiment of the disclosure, may include receiving a user input of designating a region on a display.

The operating method of an electronic device, according to an embodiment of the disclosure, may include controlling the region to operate in a mirror mode or a display mode, based on at least one of a location of a region designated based on the user input, a size of the region, an operation mode of the display, or a surrounding environment of the display.

A non-transitory computer-readable recording medium according to an embodiment of the disclosure may have recorded thereon a computer program, which, when executed by a computer, performs an operating method of an electronic device, the operating method including receiving a user input of designating a region on a display.

A non-transitory computer-readable recording medium according to an embodiment of the disclosure may have recorded thereon a computer program, which, when executed by a computer, performs an operating method of an electronic device, the operating method including controlling the region to operate in a mirror mode or a display mode, based on at least one of a location of a region designated based on the user input, a size of the region, an operation mode of the display, or a surrounding environment of the display.

### DESCRIPTION OF DRAWINGS

FIG. 1 is a view illustrating an operation of an electronic device according to an embodiment of the disclosure.

FIG. 2 illustrates a micro-light-emitting diode (micro-LED) mirror applied to a display of an electronic device according to an embodiment of the disclosure.

FIG. 3 is a flowchart of an operating method of an electronic device according to an embodiment of the disclosure.

FIG. 4 is a view illustrating a method of generating a user input of designating a region, according to an embodiment of the disclosure.

FIG. 5 is a diagram illustrating a method, performed by an electronic device, of predicting a user's intention for designating a region by using artificial intelligence (AI), according to an embodiment of the disclosure.

FIG. 6 is a diagram illustrating an example in which an electronic device according to an embodiment of the disclosure sets a mode of a region based on a usage status of a display.

FIG. 7 is a flowchart of an operating method of an electronic device according to an embodiment of the disclosure.

FIG. 8 is a diagram illustrating an example of displaying a user interface (UI) related to a physical input unit of a display on a designated region, according to an embodiment of the disclosure.

FIG. 9 illustrates an example in which an operating method of an electronic device according to an embodiment of the disclosure is applied to a transparent display.

FIG. 10 illustrates an example of an electronic device according to an embodiment of the disclosure, identifying a region on a display on which a user's face is shown and setting a mode of the region.

FIG. 11 is a diagram illustrating a method, performed by an electronic device according to an embodiment of the disclosure, of identifying a region of a display where the user's face is reflected by using AI.

FIG. 12 is a flowchart of an operating method of an electronic device according to an embodiment of the disclosure.

FIG. 13 illustrates an example of the trigger of entry into a region designation mode according to an embodiment of the disclosure.

FIG. 14 is a view illustrating an example of changing setting of a display according to a process of a user input for designating a region, according to an embodiment of the disclosure.

FIG. 15 is a diagram illustrating an example in which an electronic device according to an embodiment of the disclosure changes a mode of a display according to a user input of designating a region.

FIG. 16 is a view illustrating an operation of an electronic device according to an embodiment of the disclosure.

FIG. 17 is a block diagram of an electronic device according to an embodiment of the present disclosure.

FIG. 18 is a detailed block diagram of an electronic device according to an embodiment of the disclosure.

### MODE FOR INVENTION

Embodiments of the disclosure are described in detail herein with reference to the accompanying drawings so that the disclosure may be easily performed by one of ordinary skill in the art to which the disclosure pertains. The disclosure may, however, be embodied in many different forms and should not be construed as being limited to the examples set forth herein.

Although general terms widely used at present were selected for describing the disclosure in consideration of the functions thereof, these general terms may vary according to intentions of one of ordinary skill in the art, case precedents, the advent of new technologies, or the like. Hence, the terms must be defined based on their meanings and the contents of the entire specification, not by simply stating the terms.

The terms used in the disclosure are merely used to describe particular embodiments, and are not intended to limit the scope of the disclosure.

When an element (e.g., a first element) is “coupled to” or “connected to” another element (e.g., a second element), the first element may be directly coupled to or connected to the second element, or, unless otherwise described, a third element may exist therebetween.

The use of the terms “a” and “an” and “the” and similar referents in the context of describing the disclosure (especially in the context of the following claims) are to be construed to cover both the singular and the plural. Also, the steps of all methods described herein can be performed in any suitable order unless otherwise indicated herein or otherwise clearly contradicted by context. The disclosure is not limited to the described order of the operations.

Thus, the expression “according to an embodiment” used in the entire disclosure does not necessarily indicate the same embodiment.

The words “mechanism,” “element,” “means,” and “configuration” are used broadly and are not limited to mechanical or physical embodiments,

Embodiments of the disclosure may be described in terms of functional block components and various processing steps.

Furthermore, the connecting lines or connectors between components shown in the various figures presented are intended to represent exemplary functional relationships and/or physical or logical couplings between the components. In an actual device, a connection between components may be represented by various functional connections, physical connections, or circuit connections that are replaceable or added.

The terms “unit”, “-er (-or)”, and “module” when used in this specification refers to a unit in which at least one function or operation is performed, and may be implemented as hardware, software, or a combination of hardware and software.

The expression “configured to (or set to)” used therein may be used interchangeably with, for example, “suitable for”, “having the capacity to”, “designed to”, “adapted to”, “made to”, or “capable of”, according to situations. The expression “configured to (or set to)” may not only necessarily refer to “specifically designed to” in terms of hardware. Instead, in some situations, the expression “system configured to” may refer to a situation in which the system is “capable of” together with another device or parts. For example, the phrase “a processor configured (or set) to perform A, B, and C” may mean a dedicated processor (such as an embedded processor) for performing a corresponding operation, or a generic-purpose processor (such as a central processing unit (CPU) or an application processor (AP)) that can perform a corresponding operation by executing one or more software programs stored in memory.

The term “user” used herein denotes a person who controls a function or operation of an electronic device by using the electronic device.

The expression “at least one of A or B” or “at least one of A, or B” when used in this specification refers to including either A, B, or both A and B. Similarly, the expression “at least one of a, b or c” when used in this specification refers to only a, only b, only c, both a and b, both a and c, both b and c, or all of a, b, and c.

Embodiments of the disclosure are described in detail herein with reference to the accompanying drawings so that this disclosure may be easily performed by one of ordinary skill in the art to which the disclosure pertains. In the drawings, parts irrelevant to the description are omitted for simplicity of explanation.

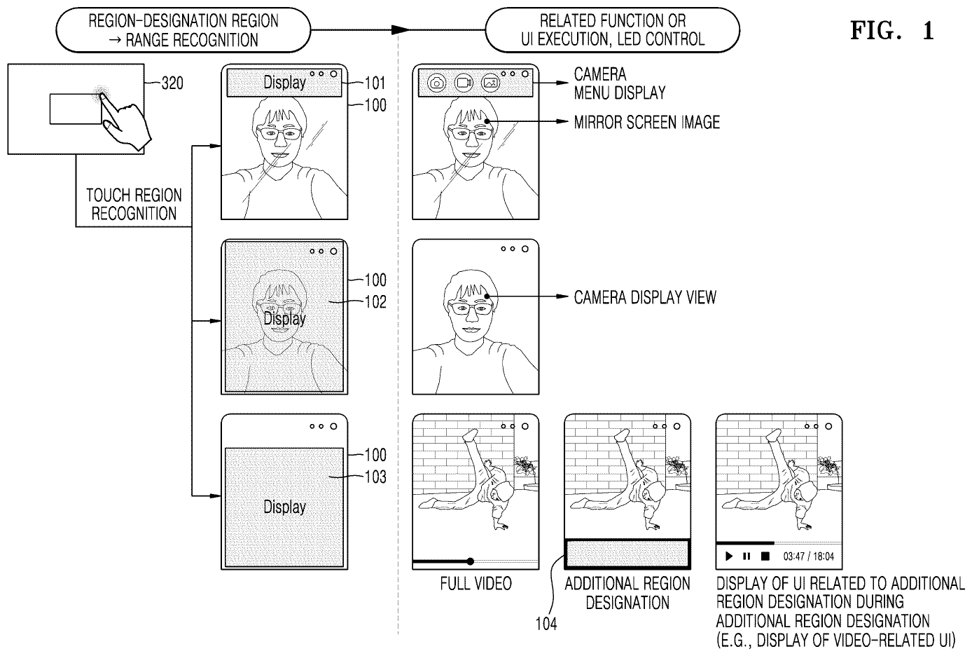

FIG. 1 is a view illustrating an operation of an electronic device 100 according to an embodiment of the disclosure.

The electronic device 100 according to an embodiment of the disclosure may include a display 320 to which a mirror display is applied. The mirror display may indicate a display capable of performing a mirror function and a display function by combining a mirror film with a display panel. The mirror display may include, for example, a micro-LED mirror.

According to an embodiment, in the electronic device 100 in which a micro-LED mirror is applied to the display 320, an LED may be controlled on a pixel-by-pixel basis, and thus, the entirety or a portion of the display may be used as a mirror.

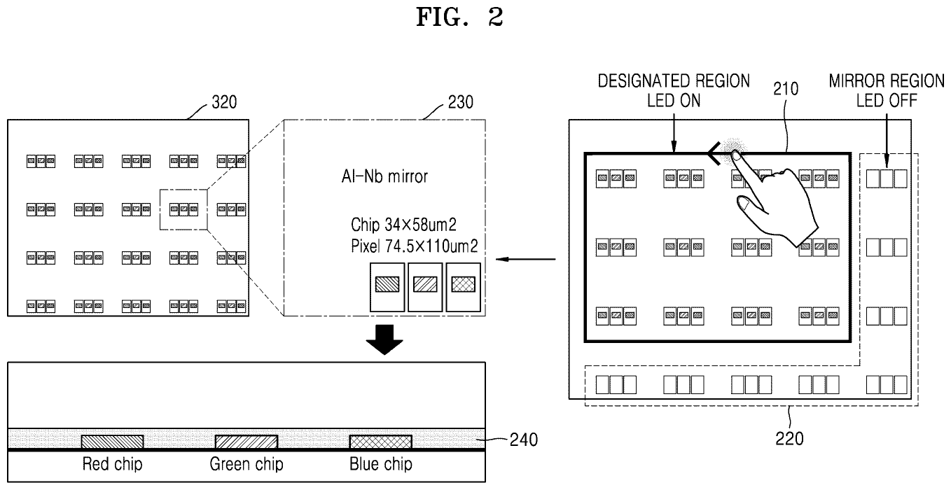

The electronic device 100 according to an embodiment of the disclosure may use, as a mirror, a region including pixels with turned-off LEDs in the display 320 to which a micro-LED mirror is applied, and may use, as a general display, a region including pixels with turned-on LEDs. This will be described in detail later with reference to FIG. 2.

According to an embodiment, the electronic device 100 may set a mode of the display 320 to a mirror mode or a display mode, by controlling the LEDs of the pixels of the display 320.

In the disclosure, the mirror mode may refer to a setting in which the LEDs of the pixels of the display 320 are turned off so that the display serves as a mirror, and the display mode may refer to a setting in which the LEDs of the pixels are turned on so that the display performs its original role of displaying content, menus, etc.

According to an embodiment, the electronic device 100 may set the entirety or a portion of the display 320 to a mirror mode or a display mode.

According to an embodiment, the electronic device 100 may set a portion of the display 320 to a mirror mode, or may set the other portion of the display 320 to a display mode.

When the electronic device 100 uses at least a portion of the display 320 in the mirror mode, the LEDs may be turned off so that energy may be saved, and usability of the display may be increased using the display for an additional function.

As shown in the embodiment of FIG. 1, the electronic device 100 may be a smartphone, but this is merely an embodiment. The electronic device 100 may be implemented in various types.

The electronic device 100 may be easily implemented as an electronic device including a video output interface, such as a smartphone. However, embodiments of the disclosure are not limited thereto. The electronic device 100 may be fixed or movable, and may be a digital broadcast receiver capable of digital broadcasting reception.

According to an embodiment of the disclosure, the electronic device 100 may be implemented as a device that performs image outputting as a function while performing another function.

The electronic device 100 according to an embodiment of the disclosure may be implemented as various types, such as a tablet PC, a smartphone, a digital camera, a camcorder, a laptop computer, a smart TV, a netbook computer, a desktop computer, an e-book terminal, a video phone, a digital broadcast terminal, personal digital assistants (PDAs), a portable multimedia player (PMP), a navigation device, a wearable device, a smart refrigerator, and other home appliances.

The electronic device 100 may have a built-in display, but embodiments of the disclosure are not limited thereto. The electronic device 100 may be implemented as a type that operates by being connected to an external display even when it does not have a built-in display.

For example, the electronic device 100 may be implemented as a type that outputs an image to a separate external display via a video or audio output port, without a display, like a settop box (STB), or with a simple display for notifications, etc.

In this case, the electronic device 100 may include an output port for outputting a video or audio signal to a display. The output port may be of a type capable of transmitting a video signal and an audio signal simultaneously, such as an HDMI, a DP, or a thunderbolt, or may be of a type having separate ports that transmit a video signal and an audio signal separately.

According to an embodiment of the disclosure, the electronic device 100 may transmit a video or audio signal via wired or wireless communication.

The electronic device 100 may be implemented as not only an electronic device having a flat display but also an electronic device having a curved display having a curvature or a flexible electronic device with an adjustable curvature. An output resolution of the electronic device 100 may be, for example, a high definition (HD), a full HD, an ultra-HD, or a resolution that is clearer than an ultra-HD.

According to an embodiment of the disclosure, the electronic device 100 may receive a user input of designating a region on the display 320.

According to an embodiment of the disclosure, the user input may be a touch input.

According to an embodiment of the disclosure, the electronic device 100 may predict a user's intention for designating a region, based on at least one of the region's location, the region's size, a usage status of the display 320, or a surrounding environment of the display 320.

According to an embodiment of the disclosure, the electronic device 100 may set the designated region as a mirror mode or a display mode according to the predicted user's intention.

According to an embodiment of the disclosure, the electronic device 100 may include a camera lens on the display 320, and may receive a user input of designating a region 101 whose size occupies less than a threshold value of the entire area of the display 320. At a point in time when this user input is received, the display 320 may be in a state of being entirely set as the mirror mode.

According to an embodiment of the disclosure, when the region 101 is designated according to the user input, the electronic device 100 may set the designated region as a display mode and display a menu related to a camera on the designated region. According to an embodiment of the disclosure, the menu related to a camera may include a photo shooting menu, a video shooting menu, and an album review menu.

According to an embodiment of the disclosure, the electronic device 100 may capture an image of a user reflected on a region of the display 320 set as a mirror mode by using a menu related to a camera displayed on the designated region.

According to an embodiment of the disclosure, the electronic device 100 may include a camera lens on the display 320, and may receive a user input of designating a region 102 whose size is equal to or greater than the threshold value of the area of the display 320.

According to an embodiment of the disclosure, when the region 102 is designated, the electronic device 100 may set the designated region 102 as a display mode and execute a camera application on the designated region. According to an embodiment of the disclosure, the electronic device 100 may display a camera shooting standby screen, i.e., a camera display view, on the designated region.

According to an embodiment of the disclosure, when the designated region includes a sensor and the size of the designated region is equal to or greater than a first threshold value of the area of the display, the electronic device 100 may set the designated region as a display mode and execute an application related to the sensor on the designated region.

According to an embodiment of the disclosure, the electronic device 100 may include no camera lenses on the display 320, and may receive a user input of designating a region 103 whose size is equal to or greater than the threshold value of the area of the display 320.

According to an embodiment of the disclosure, when the region 103 is designated, the electronic device 100 may set the designated region 103 as a display mode and execute a pre-determined application on the designated region. According to an embodiment of the disclosure, the pre-determined application may be a video playback application.

According to an embodiment of the disclosure, when the region 103 is designated, the electronic device 100 may execute a video playback application on the designated region.

According to an embodiment of the disclosure, the electronic device 100 may execute a video playback application on the entire area of the display 320, such as the region 103, if a region that is specified does not include a camera lens on the display 320 and a size thereof is greater than or equal to the threshold value of the area of the display 320.

According to an embodiment of the disclosure, when the designated region includes no sensors and the size of the designated region is equal to or greater than the threshold value of the area of the display, the electronic device 100 may set the designated region as a display mode and execute a pre-determined application on the designated region.

According to an embodiment of the disclosure, while the region 103 is being designated and a video playback application is being executed on the designated region 103, the electronic device 100 may receive a user input of designating an additional region 104 on a portion of the designated region 103 in which a video playback application is being executed.

According to an embodiment of the disclosure, when the additional region 104 is designated on the portion of the designated region 103 in which a video playback application is being executed, the electronic device 100 may display a menu related to the currently-being-executed video playback application on the designated additional region 104.

According to an embodiment of the disclosure, the electronic device 100 may obtain a menu frequently used by the user, by using an artificial intelligence (AI) model that has learned the user's menu usage pattern related to the video playback application, and may display the menu on the additionally designated region 104.

According to an embodiment of the disclosure, when a region is designated according to a user input within a region where an application is being executed, the electronic device 100 may display a user interface (UI) related to the currently-being-executed application on the designated region.

According to an embodiment of the disclosure, when a region is designated according to a user input within a region where an application is being executed, the electronic device 100 may display a menu highly frequently used in relation to the currently-being-executed application on the designated region.

According to an embodiment of the disclosure, the electronic device 100 may obtain a menu highly frequently used by the user, by using an AI model that has learned the user's application usage pattern.

According to an embodiment of the disclosure, when a region is designated according to a user input within a region where a YouTube application is being executed, the electronic device 100 may display, on the designated region, a 1.5× speed playback menu and a 2× speed playback menu identified as being frequently used by the user in relation to the currently-being-executed YouTube application.

According to an embodiment of the disclosure, when a region is designated according to a user input within a region where a camera application is being executed, the electronic device 100 may display, on the designated region, a filter menu, a cropping menu, etc. identified as being frequently used by the user in relation to the currently-being-executed camera application.

The embodiment of FIG. 1 is only an example, and a method of adjusting the mode of the display 320 by predicting the intention of a user who has designated a region is not limited thereto.

FIG. 2 illustrates a micro-LED mirror applied to a display of an electronic device according to an embodiment of the disclosure.

The display 320 to which the micro-LED mirror has been applied may include an LED capable of adjusting brightness and On/Off for each pixel 230 of the display 320, and the LED may include a red chip, a green chip, and a blue chip.

The display 320 to which the micro-LED mirror has been applied may be a display in which a mirror glass 240 is coated on a layer on which LEDs such as a red chip, a green chip, and a blue chip are arranged.

The display 320 to which the micro LED mirror has been applied may apply a mirror coating on a pixel so that, when the LED is in an on state, light emitted from RGB pixels passes through a mirror film and thus the colors of pixels are shown, thereby displaying an image, and, when the LED is in an off state, surrounding's light may be reflected and thus a surface of the display may appear like a mirror.

According to an embodiment of the disclosure, the electronic device 100 may set a region 210 designated by the user to a display mode, by turning on an LED of the region 210.

According to an embodiment of the disclosure, the electronic device 100 may set a region 220 other than the region 210 designated by the user to a mirror mode, by turning off an LED of the region 220.

According to an embodiment of the disclosure, the electronic device 100 may save energy by setting a portion or the entirety of the display 320 to a mirror mode.

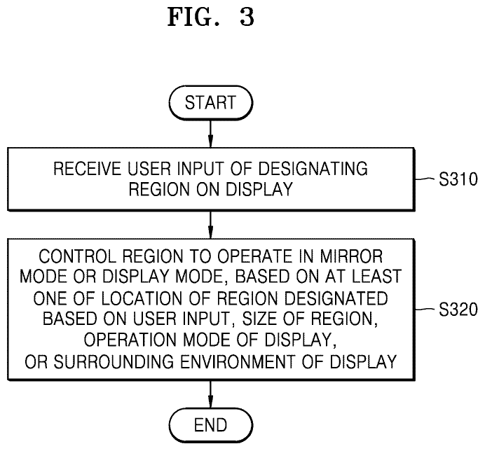

FIG. 3 is a flowchart of an operating method of an electronic device according to an embodiment of the disclosure.

Referring to FIG. 3, the electronic device 100 according to an embodiment of the disclosure may receive a user input of designating a region on the display 320 (S310).

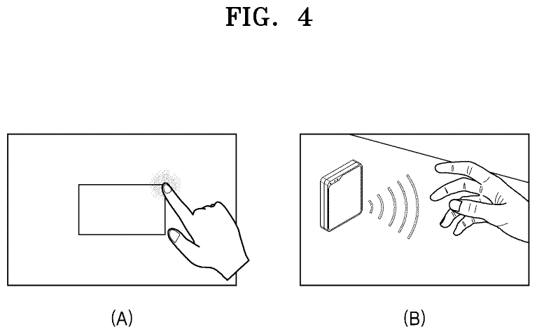

FIG. 4 is a view illustrating a method of generating a user input of designating a region, according to an embodiment of the disclosure.

According to an embodiment of the disclosure, the user input of designating a region may take the form of a contact input including a touch input such as (A) of FIG. 4 and a non-contact input including a gesture input such as (B) of FIG. 4.

According to an embodiment of the disclosure, when the user input is a touch input, the electronic device 100 may identify the user input by detecting a change in the electrostatic capacitance of the display 320.

According to an embodiment of the disclosure, when the user input is a gesture input, the electronic device 100 may identify a user's gesture by using various sensors such as a camera and an infrared sensor.

In addition, the user input of designating a region may take the form of a non-contact input including an input generated by an remote device, such as a remote controller, and a voice input.

In the embodiment of FIG. 1, a region is designated as a quadrilateral shape, but it does not necessarily have to be designated as a quadrilateral shape and may be freely designated by a user.

According to an embodiment of the disclosure, the electronic device 100 may receive a user input of designating a region by swiping the display 320 in an up, down, left, or right direction. This will be described in detail later.

According to an embodiment of the disclosure, the electronic device 100 may obtain a user input in various ways by using at least one sensor, in addition to the aforementioned methods.

According to an embodiment of the disclosure, the electronic device 100 may control the region to operate in a mirror mode or a display mode, based on at least one of a location of a region designated based on the user input, a size of the region, an operation mode of the display 320, or a surrounding environment of the display 320 (S320).

According to an embodiment of the disclosure, the location of the region may include information about whether the location of the region is a location including a physical structure of the electronic device 100, such as a camera lens, whether the location of the region includes a physical input unit of the display 320, such as a power button or a volume control button, whether the location of the region is a location adjacent to a physical input unit of the display 320, such as a power button or a volume control button, and whether the location of the region is a location on the display 320 where the user's face is reflected.

According to an embodiment of the disclosure, the size of the region may include information about whether the size of the designated region is greater than or equal to a predetermined size.

According to an embodiment of the disclosure, the predetermined size may refer to 50%, 25%, or the like of the area of the display 320.

According to an embodiment of the disclosure, an operation mode of the display 320 may include information about whether a mode of the display 320 is a mirror mode or a display mode at a point of time when a user input is received and what application is executed on the display.

According to an embodiment of the disclosure, the surrounding environment of the display 320 having a designated region may include information about an illumination around the display 320, a distance between the display 320 having a designated region and the user, and a location of the user at a point of time when the region is designated.

According to an embodiment of the disclosure, the electronic device 100 may predict the intention of a user who has designated a region, by using an AI model or by using an algorithm using a scenario.

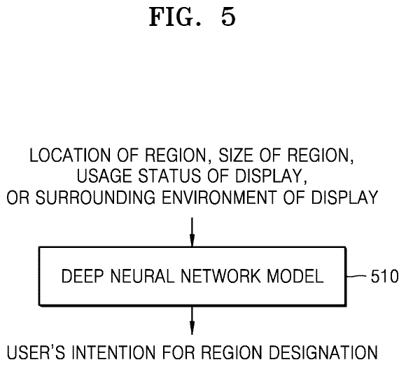

An embodiment of predicting the intention of a user who has designated a region by using an AI model will be described later with reference to FIG. 5.

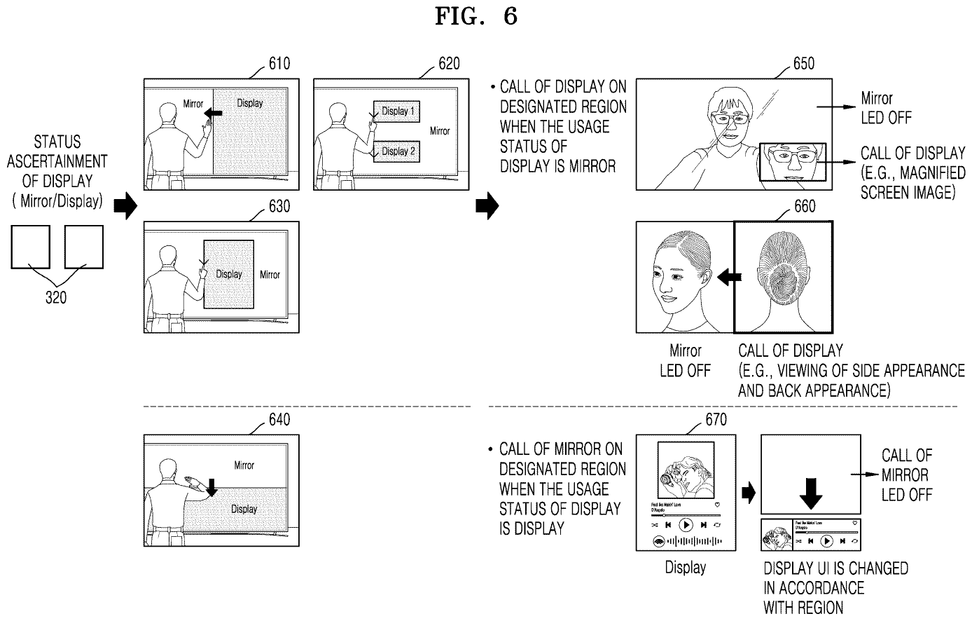

An embodiment of predicting the intention of a user who has designated a region by using a scenario will be described later with reference to FIGS. 6 through 9 and FIG. 11.

The same result as a result of FIGS. 6 through 9 and FIG. 11 may be derived by an embodiment of predicting the intention of a user who has designated a region by using an AI model.

According to an embodiment of the disclosure, the electronic device 100 may set the designated region as a mirror mode or a display mode according to the predicted user's intention.

According to an embodiment of the disclosure, when the designated region is set to a mirror mode, the electronic device 100 may allow the designated region to be used as a mirror.

According to an embodiment of the disclosure, when the designated region is set to a display mode, the electronic device 100 may allow the designated region to be used for general display purposes.

FIG. 5 is a diagram illustrating a method, performed by an electronic device, of predicting a user's intention for designating a region by using artificial intelligence (AI), according to an embodiment of the disclosure.

The electronic device 100 according to an embodiment of the disclosure may identify a user's intention for designating a region, based on at least one of a location of the designated region, a size of the designated region, a usage status of a display, or a surrounding environment of the display.

AI, which is a computer system that implements human-level intelligence, trains itself, and increases a recognition rate the more the AI is used. The AI includes a machine learning (deep learning) technology of using an algorithm that classifies/learns the features of pieces of input data by itself, and element technologies of mimicking functions, such as recognition and determination by human brains, by utilizing a machine learning algorithm.

For example, the element technologies may include at least one of linguistic understanding technology that recognizes human language/text, visual understanding technology that recognizes objects like human vision, deduction/prediction that logically performs deduction and prediction by determining information, knowledge representation that processes human experience information as knowledge data, vehicle's autonomous traveling, or operation control for controlling a motion of a robot.

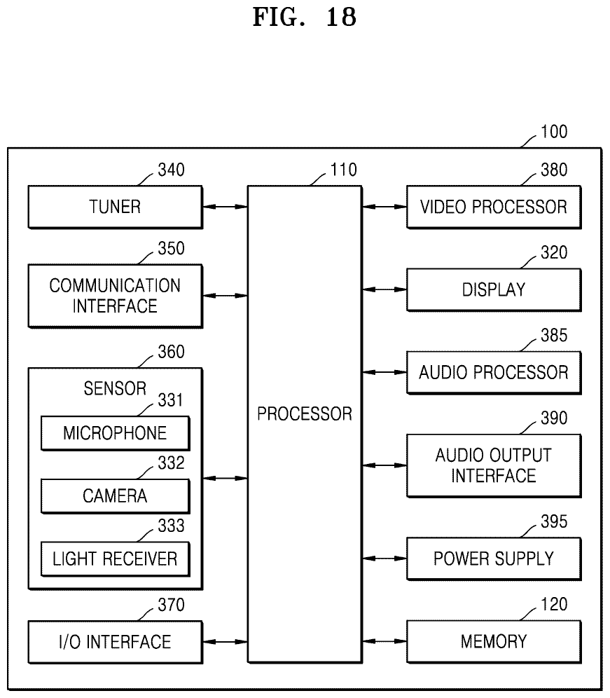

A function related to AI according to an embodiment of the disclosure may be operated through a processor 110 and memory 120 of FIG. 18. The processor 110 may be implemented as one or a plurality of processors. The one or plurality of processors may be a general-purpose processor such as a central processing unit (CPU), an application processor (AP), or a digital signal processor (DSP), a graphics-only processor such as a graphics processing unit (GPU) or a vision processing unit (VPU), or an AI-only processor such as a neural processing unit (NPU). The one or plurality of processors 110 control to process input data, according to a predefined operation rule or AI model stored in the memory 120. Alternatively, when the one or plurality of processors 110 are AI-only processors, the AI-only processors may be designed in a hardware structure specialized for processing a specific AI model.

The predefined operation rule or AI model is characterized in that it is created through learning. Here, being created through learning means that a basic AI model is trained using a plurality of training data by a learning algorithm, so that a predefined operation rule or AI model set to perform desired characteristics (or a desired purpose) is created. Such learning may be performed in the electronic device 100 itself on which AI according to the disclosure is performed, or may be performed through a separate server and/or system. Examples of the learning algorithm include, but are not limited to, supervised learning, unsupervised learning, semi-supervised learning, or reinforcement learning.

The AI model may be composed of a plurality of neural network layers. Each of the plurality of neural network layers has a plurality of weight values, and performs a neural network operation through an operation between an operation result of a previous layer and the plurality of weight values. The plurality of weight values of the plurality of neural network layers may be optimized by a learning result of the AI model. For example, the plurality of weight values may be updated so that a loss value or a cost value obtained from the AI model is reduced or minimized during a learning process.

In an embodiment using a deep learning algorithm, the processor 110 may predict a user's intention for designating a region, by using a pre-trained deep neural network model 510.

The deep neural network model 510 may be an AI model trained via a learning process of predicting a user's intention for designating a region by obtaining, as an input, at least one of the region's location, the region's size, a usage status of the display 320, or a surrounding environment of the display 320.

The deep neural network model may be, for example, a convolutional neural network (CNN) model. However, embodiments of the present disclosure are not limited thereto, and the deep neural network model may be a well-known AI model including at least one of a Recurrent Neural Network (RNN), a Restricted Boltzmann Machine (RBM), a Deep Belief Network (DBN), a Bidirectional Recurrent Deep Neural Network (BRDNN), or Deep Q-Networks.

The electronic device 100 may determine the importance of a received notification message by using various machine learning algorithms using a regression model, a multiple linear regression analysis, etc.

FIG. 6 is a diagram illustrating an example in which an electronic device according to an embodiment of the disclosure sets a mode of a region, based on a usage status of a display.

The electronic device 100 according to an embodiment of the disclosure may set a mode of a region designated by a user, based on a usage status of the display 320.

The electronic device 100 according to an embodiment of the disclosure may identify whether the display 320 is being used in a mirror mode or in a display mode.

When the display 320 is simultaneously used in a mirror mode and a display mode, the electronic device 100 according to an embodiment of the disclosure may individually identify a region being used in a mirror mode and a region being used in a display mode.

While the display 320 is being used in a mirror mode as in 650, the electronic device 100 according to an embodiment of the disclosure may receive a user input of designating a quadrilateral region through a user input as in 630. The user input may be either a contact input or a non-contact input.

When receiving an input of designating a region from a user while the display 320 is being used in a mirror mode as in 650, the electronic device 100 according to an embodiment of the disclosure may set a designated region to a display mode.

The electronic device 100 according to an embodiment of the disclosure may identify the fact that a user is putting a makeup in a mirror mode.

When receiving an input of designating a region from a user as in 620 while the user is putting a makeup in a mirror mode, the electronic device 100 according to an embodiment of the disclosure may set the designated region to a display mode, and may display, on the designated region, an enlarged image of a region that the user is currently focusing on in a mirror region. According to an embodiment of the disclosure, this enlarged image may be captured by a camera.

When receiving an input of designating a region from a user as in 620 while the user is putting a makeup in a mirror mode, the electronic device 100 according to an embodiment of the disclosure may set the designated region to a display mode, and may display, on the designated region, an introductory image on how to apply makeup, a cosmetics introducing image, an image on how to use makeup tools, or other educational images.

According to an embodiment of the disclosure, such an image may be searched for in real time. According to an embodiment of the disclosure, such an image may be of a face part on which a user is currently applying a makeup. Examples of the face part may include eyes, nose, mouth, forehead, and cheek.

While the display 320 is being used in a mirror mode as in 660, the electronic device 100 according to an embodiment of the disclosure may receive a user input of designating a region through a user input via swiping as in 610. The user input may be an input of swiping a display from left to right. According to an embodiment of the disclosure, the electronic device 100 may identify a left region created by the swiping input as a region designated by a user.

When receiving a user input generated via swiping as in 610 while the display 320 is being used in a mirror mode as in 660, the electronic device 100 according to an embodiment of the disclosure may set a designated region to a display mode, and display a side appearance or back appearance of the user on the designated region. According to an embodiment of the disclosure, an image of the side or back appearance may be captured by a camera in advance.

While the display 320 is being used in a mirror mode as in 670, the electronic device 100 according to an embodiment of the disclosure may receive a user input of designating a region through a user input via swiping as in 640. The user input may be an input of swiping a display from top to bottom. The user input may be either a contact input or a non-contact input.

The electronic device 100 according to an embodiment of the disclosure may identify a state in which an image is being reproduced, as in 670, in a display mode.

When receiving an input of swiping the display 320 from top to bottom as in 640 while an image is being reproduced as in 670 in a display mode, the electronic device 100 according to an embodiment of the disclosure may identify an upper region created by the swiping input as a region designated by the user.

When receiving an input of swiping the display 320 from top to bottom as in 640 while an image is being reproduced as in 670 in a display mode, the electronic device 100 according to an embodiment of the disclosure may set the designated region to a mirror mode.

When receiving an input of swiping the display 320 from top to bottom as in 640 while an image is being reproduced as in 670 in a display mode, the electronic device 100 according to an embodiment of the disclosure may set the designated region to a mirror mode, and may change a region where an existing image was reproduced, in accordance with a reduced size.

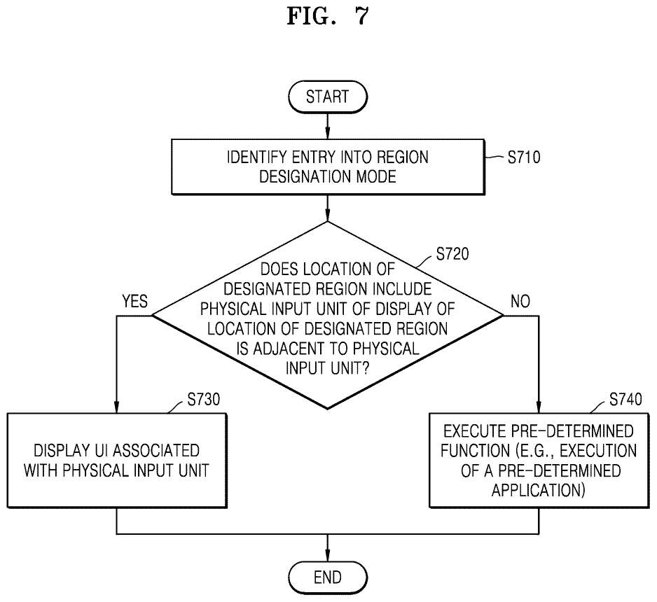

FIG. 7 is a flowchart of an operating method of an electronic device according to an embodiment of the disclosure.

Referring to FIG. 7, the electronic device 100 according to an embodiment of the disclosure may identify entry into a region designation mode (S710).

The electronic device 100 according to an embodiment of the disclosure may identify entry into a region designation mode by detecting a trigger.

According to an embodiment of the disclosure, the trigger may be at least one of a predetermined gesture including a depth long press, a predetermined voice, or a predetermined touch recognition.

In the disclosure, the depth long press may refer to making a gesture of pressing a button or the display 320 in the air, without directly touching the display 320.

When entry into a region designation mode is identified, the electronic device 100 according to an embodiment of the disclosure may identify a subsequent user input as a region designation input for setting a mode of a display.

The electronic device 100 according to an embodiment of the disclosure may identify whether a location of a designated region includes a physical input unit of the display 320 or is adjacent to the physical input unit of the display 320 (S720).

The electronic device 100 according to an embodiment of the disclosure may recognize features related to the designated region.

According to an embodiment of the disclosure, the features related to the designated region may include a location of a region, a size of the region, a usability status of the display 320 on which a region is designated, and a surrounding environment of the display 320 on which the region is designated.

According to an embodiment of the disclosure, the location of the region may include information about whether the location of the region is a location including a physical structure of a camera lens or the like, whether the location of the region includes a physical input unit of the display 320, such as a power button or a volume control button, whether the location of the region is a location adjacent to a physical input unit of the display 320, such as a power button or a volume control button, and whether the location of the region is a location on the display 320 where the user's face is reflected.

When the location of the region includes a physical input unit of the display 320 or is adjacent to the physical input unit of the display 320, the electronic device 100 according to an embodiment of the disclosure may display a UI associated with the physical input unit (S730).

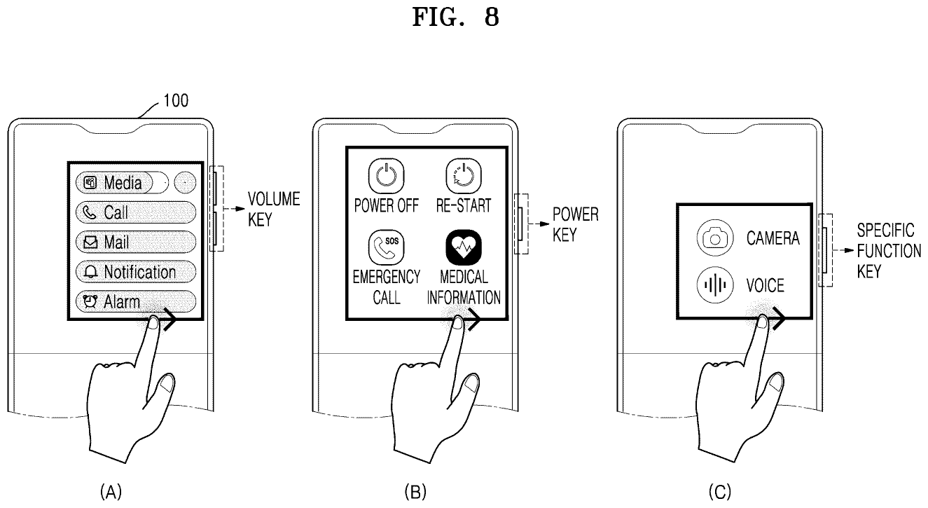

An example in which, when receiving, via a user input, a region including the physical input unit of the display 320 or being adjacent to the physical input unit of the display 320, the electronic device 100 according to an embodiment of the disclosure displays a UI associated with the physical input unit will be described later with reference to FIG. 8.

When the location of the region does not include the physical input unit of the display 320 or is not adjacent to the physical input unit of the display 320, the electronic device 100 according to an embodiment of the disclosure may execute a pre-determined function (S740).

According to an embodiment of the disclosure, the pre-determined function may be execution of a pre-determined application. The pre-determined function may be set by a user of the electronic device 100.

According to an embodiment of the disclosure, the pre-determined function may be a function of reproducing a recently-watched video by executing a video playback application, such as an OTT application.

According to an embodiment of the disclosure, the pre-determined function may be a function of reproducing a recently-listened music by executing a music streaming application.

According to an embodiment of the disclosure, the pre-determined function may be a function of providing directions to a recent destination by executing a navigation application.

FIG. 8 is a diagram illustrating an example of displaying a UI related to a physical input unit of a display on a designated region, according to an embodiment of the disclosure.

When the location of the designated region includes a physical input unit of the display 320 or is adjacent to the physical input unit of the display 320, the electronic device 100 according to an embodiment of the disclosure may display a UI associated with the physical input unit.

In the embodiment of (A) of FIG. 8, when the location of the designated region includes a volume button or is adjacent to the volume button, the electronic device 100 may display a UI associated with volume adjustment.

In the embodiment of (A) of FIG. 8, the electronic device 100 may display applications that may need volume adjustment, on the designated region. Examples of the applications that may need volume adjustment include a media application, a phone application, a ringtone application, a notification application, and an alarm application.

In the embodiment of (A) of FIG. 8, the electronic device 100 displays applications capable of controlling a volume on the designated region, in response to a user input of designating a region adjacent to the volume button, thereby controlling the volume of an application selected by a user by using the volume button.

In the embodiment of (B) of FIG. 8, when the location of the designated region includes a power button or is adjacent to the power button, the electronic device 100 may display a UI associated with power.

In the embodiment of (B) of FIG. 8, the electronic device 100 may display functions associated with power, on the designated region. According to an embodiment of the disclosure, examples of the power-related functions may include power off, restart, emergency call, and medical information.

In the embodiment of (B) of FIG. 8, the electronic device 100 displays the power-related functions on the designated region, in response to a user input of designating a region adjacent to the power button, thereby allowing the user to conveniently execute a selected function.

In the embodiment of (C) of FIG. 8, when the location of the designated region includes a button for executing a specific function or is adjacent to the button for executing a specific function, the electronic device 100 may display a UI associated with the button.

In the embodiment of (C) of FIG. 8, the button for executing a specific function may be a button for executing a generative AI.

In the embodiment of (C) of FIG. 8, the electronic device 100 displays functions associated with a generative AI on the designated region, in response to a user input of designating a region adjacent to the button for executing a generative AI, thereby allowing the user to conveniently execute a selected function. According to an embodiment of the disclosure, examples of the functions associated with a generative AI may include a camera function and a voice function.

The electronic device 100, according to an embodiment of the disclosure, may set the display, on which a micro LED mirror has been applied, to a mirror mode or a display mode, based on the characteristics of the region designated by the user, regardless of the region's location.

When the electronic device 100 according to an embodiment of the disclosure is a smartphone and both the front and the back of the smartphone are implemented as displays to which micro LED mirrors have been applied, both the front and the back may set the display to a mirror mode or a display mode, based on the characteristics of the region designated by the user.

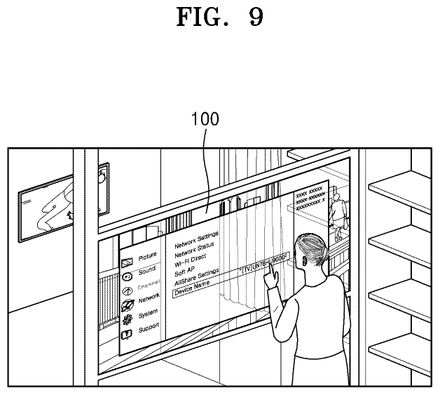

FIG. 9 illustrates an example in which an operating method of an electronic device according to an embodiment of the disclosure has been applied to a transparent display.

The electronic device 100 according to an embodiment of the disclosure may be a device to which a transparent display has been applied as shown in FIG. 9.

When a micro-LED mirror has been applied to a transparent display as shown in FIG. 9, the electronic device 100 according to an embodiment of the disclosure may set the transparent display to a mirror mode or a display mode, based on the characteristics of a region designated by a user.

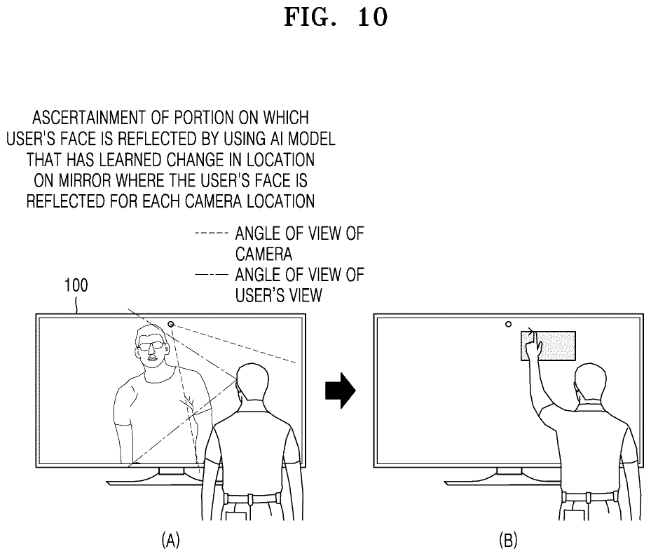

FIG. 10 illustrates an example of an electronic device according to an embodiment of the disclosure, identifying a region on a display on which a user's face is shown and setting a mode of the region.

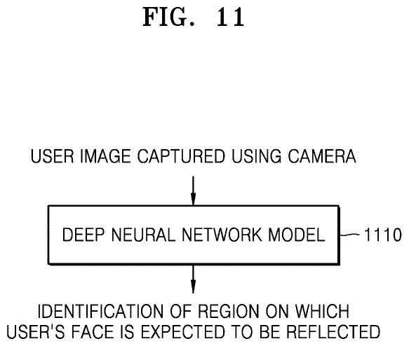

The electronic device 100 according to an embodiment of the disclosure may identify a location of the display where the user's face is reflected by using an AI model that has learned a location where the user's image captured by a camera is reflected in a mirror. This will be described in detail later with reference to FIG. 11.

When the setting to a mirror mode is changed, the electronic device 100 according to an embodiment of the disclosure may identify a region on the display where the user's face is expected to be reflected. When the region designated by the user includes the region on the display where the user's face is expected to be reflected, the electronic device 100 according to an embodiment of the disclosure may set the designated region to a mirror mode, and, when the designated region does not include the region where the user's face is expected to be reflected, may set the designated region to a display mode.

When the region designated by a user includes a significant portion of the region where the user's face is expected to be reflected, the electronic device 100 according to an embodiment of the disclosure may set the designated region to a mirror mode.

According to an embodiment of the disclosure, the significant portion of the region where the user's face is expected to be reflected may be a region including 80% or more of important body parts such as eyes, nose, mouth, and forehead, or including 50% or more of a face.

According to an embodiment of the disclosure, the significant portion of the region where the user's face is expected to be reflected may be a region determined to be a region that the user may want to see through the mirror.

FIG. 11 is a diagram illustrating a method, performed by an electronic device according to an embodiment of the disclosure, of identifying a region of a display where the user's face is reflected by using AI.

Any content that overlaps with contents regarding AI explained above with reference to FIG. 5 may be omitted.

When setting to a mirror mode is changed through a trained neural network based on an image of a user captured using a camera and a display region on which the face of the user at a location where the image has been captured is actually reflected, the electronic device 100 according to an embodiment of the disclosure may identify a region of the display 320 on which the user's face is expected to be reflected.

In an embodiment using a deep learning algorithm, the processor 110 may identify the region of the display 320 on which the user's face is expected to be reflected, by using a pre-trained deep neural network model 1110.

The pre-trained deep neural network model 1110 may be an AI model trained through a learning process of obtaining the user's image captured by a camera as an input and outputting the region of the display 320 where the user's face is expected to be reflected.

The electronic device 100 may output the region of the display 320 where the user's face is reflected, by using any of various machine learning algorithms.

According to an embodiment of the disclosure, the pre-trained deep neural network model 1110 may learn the user's image captured using a camera and the display region on which the face of the user is reflected.

According to an embodiment of the disclosure, the pre-trained deep neural network model 1110 may be an AI model trained to obtain the user's image as an input value by using the camera by learning a region on a display on which the user's face is reflected for each location of the camera, and output the region on the display where the user's face is expected to be reflected when the mode of the display 320 is changed to a mirror mode.

According to an embodiment of the disclosure, the learning may be performed separately by a server or may be performed by the electronic device 100 itself.

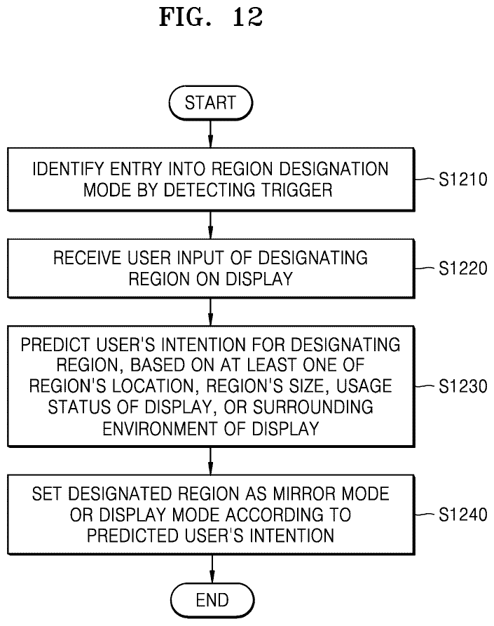

FIG. 12 is a flowchart of an operating method of an electronic device according to an embodiment of the disclosure.

Referring to FIG. 12, the electronic device 100 according to an embodiment of the disclosure may identify entry into a region designation mode by detecting a trigger (S1210).

The trigger may include at least one of gesture recognition including a depth long press, voice recognition, or predetermined touch recognition.

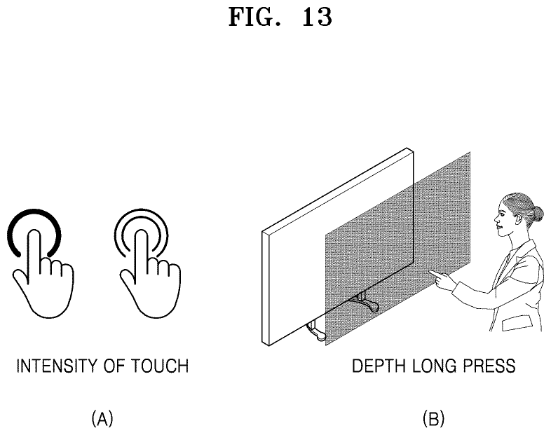

FIG. 13 illustrates an example of the trigger of entry into a region designation mode according to an embodiment of the disclosure.

As shown in (A) of FIG. 13, the electronic device 100 according to an embodiment of the disclosure may recognize detection of the intensity of a determined touch as a trigger. For example, when the electronic device 100 detects an intensity of a touch significantly weaker or stronger than the intensity of a general touch, the electronic device 100 may identify the detected touch input as a trigger.

As shown in (B) of FIG. 13, when the electronic device 100 according to an embodiment of the disclosure may recognizes a pre-determined gesture or voice of a user, the electronic device 100 may identify this recognition as a trigger.

When the electronic device 100 according to an embodiment of the disclosure may identifies a predetermined voice command or a determined gesture, such as a depth long press, the electronic device 100 may identify the voice command or the determined gesture as a trigger.

When a touch input is received not in a situation where a menu may be pressed or when a depth long press is recognized, the electronic device 100 according to an embodiment of the disclosure may start a region designation mode by recognizing a user's intention to designate a region.

The electronic device 100 according to an embodiment of the disclosure may receive a user input of designating a region on the display 320 (S1220).

According to an embodiment of the disclosure, the electronic device 100 may predict a user's intention for designating a region, based on at least one of the region's location, the region's size, a usage status of the display 320, or a surrounding environment of the display 320 (S1230).

According to an embodiment of the disclosure, the electronic device 100 may set the designated region as a mirror mode or a display mode according to the predicted user's intention (S1240).

Operation S1220 of FIG. 12 may correspond to operation S310 of FIG. 3, and operations S1230 and S1240 of FIG. 12 may correspond to operation S320 of FIG. 3. Thus, descriptions of FIG. 12 that are the same as given above with reference to FIG. 3 will not be repeated herein.

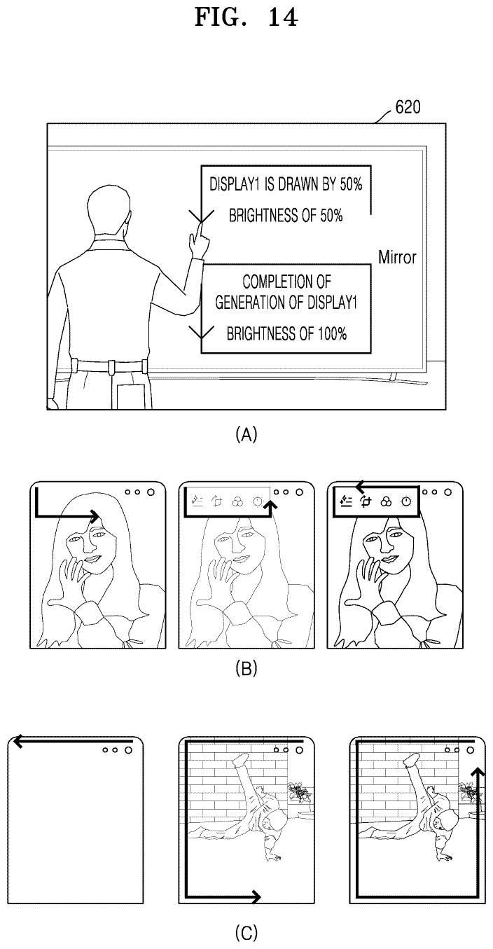

FIG. 14 is a view illustrating an example of changing setting of a display according to a process of a user input for designating a region, according to an embodiment of the disclosure.

The electronic device 100 according to an embodiment of the disclosure may adjust a brightness change speed of a display 320 according to the speed of the user input for designating a region.

When the designated region is changed from a mirror mode to a display mode, the electronic device 100 according to an embodiment of the disclosure may turn on an LED of a pixel of the designated region. Accordingly, a brightness of the display 320 may be changed brightly.

When the designated region is changed from a display mode to a mirror mode, the electronic device 100 according to an embodiment of the disclosure may turn off the LED of the pixel of the designated region. Accordingly, the brightness of the display 320 may be changed darkly.

When setting a display mode and a mirror mode, the electronic device 100 according to an embodiment of the disclosure may gradually change the setting by matching the speed of a hand performing the user input and the speed of the change in the brightness of the display 320.

When a user quickly designates a region, the electronic device 100 according to an embodiment of the disclosure may quickly change the brightness of the display 320, and, when the user slowly designates a region, may slowly change the brightness of the display 320 according to the slow speed.

The electronic device 100 according to an embodiment of the disclosure may detect the speed of region designation by checking a region designated by a touch or gesture in units of time.

The electronic device 100 according to an embodiment of the disclosure may identify a movement distance by extracting a start position and an end position of the region designated by a touch or gesture, and may detect the speed of region designation by using the movement distance per unit time.

The electronic device 100 according to an embodiment of the disclosure may gradually change the brightness of the display 320 according to the speed of the detected region designation.

The electronic device 100 according to an embodiment of the disclosure may gradually change the brightness of the display 320 according to the detected speed of the region designation and the surrounding illuminance of the display 320.

The electronic device 100 according to an embodiment of the disclosure may gradually change the brightness of the display 320 according to the illuminance around the display 320.

The electronic device 100 according to an embodiment of the disclosure may slowly change the brightness of the display 320 in order to prevent glare or the like due to a rapid change in brightness when the surrounding illuminance of the display 320 is low.

The electronic device 100 according to embodiment (A) of FIG. 14 may adjust the brightness of the display 320 by 50% when 50% of the region designated by the user is drawn, and may adjust the brightness of the display 320 by 100% when 100% of the region designated by the user is drawn.

The electronic device 100 according to an embodiment of the disclosure may gradually change the brightness and mode setting of the display 320 by inferring a region to be completed when three corners of the region designated by the user are drawn and a mode to be set for the region.

The electronic device 100 according to embodiment (B) of FIG. 14 may receive a user input of designating a region while the display 320 is being used in a mirror mode.

The electronic device 100 according to embodiment (B) of FIG. 14 may predict a region to be completed when three corners of the region designated by the user are drawn and a mode to be set for the region.

Because the designated region is adjacent to a camera lens and a size of the region is less than 50% of a size of the display 320, the electronic device 100 according to embodiment (B) of FIG. 14 may set the designated region to a display mode, and may predict display of a UI related to a camera.

The electronic device 100 according to embodiment (B) of FIG. 14 may predict that when three corners of an area designated by a user are drawn, the designated area will be set to a display mode and a UI related to a camera will be displayed, change the brightness of the display to 50%, and display the UI related to the camera with a sharpness of about 50%.

The electronic device 100 according to embodiment (C) of FIG. 14 may receive a user input of designating a region while the display 320 is being used in a mirror mode.

The electronic device 100 according to embodiment (C) of FIG. 14 may predict a region to be completed when three corners of the region designated by the user are drawn and a mode to be set for the region.

Because the designated region includes a camera lens and a size of the region is equal to or greater than 50% of a size of the display 320, the electronic device 100 according to embodiment (C) of FIG. 14 may set the designated region to a display mode, and may predict execution of an image view of a camera.

The electronic device 100 according to an embodiment of the disclosure may predict that a designated region is set to a display mode and a camera application is to be executed when three corners of a region designated by a user are drawn, change the brightness of the display to be bright by 50%, and display a camera application execution view with about 50% clarity.

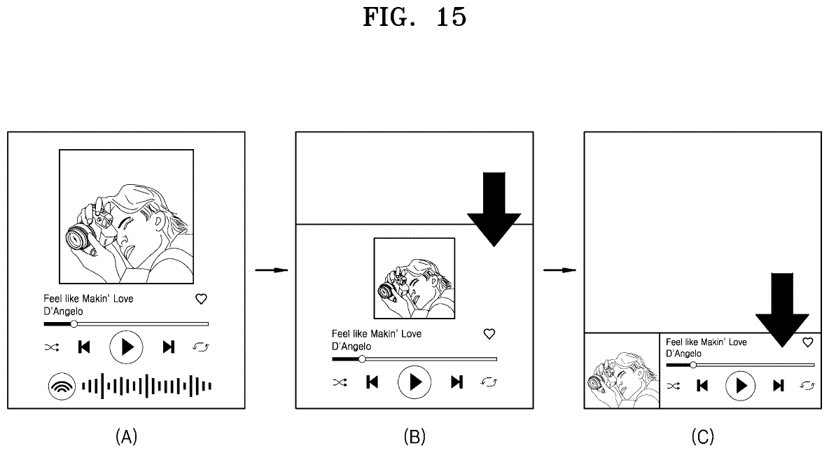

FIG. 15 is a diagram illustrating an example in which an electronic device according to an embodiment of the disclosure changes a mode of a display according to a user input of designating a region.

The electronic device 100 according to an embodiment of the disclosure may adjust a brightness change speed of the display 320 according to the speed of swiping, even when the user input is in the form of swiping the display 320, similar to the case of region designation described above with reference to FIG. 14.

In the embodiment of (A) of FIG. 15, the electronic device 100 may set the display 320 to a display mode and may execute a video playback application.

In the embodiment of (B) of FIG. 15, the electronic device 100 may receive a user input of swiping the display 320 from top to bottom.

In the embodiment of (C) of FIG. 15, the electronic device 100 may continuously receive a user input of swiping the display 320 from top to bottom.

In the embodiments of (B) and (C) of FIG. 15, the electronic device 100 may identify a region newly formed on the upper side according to the user's swiping input, as a region designated by a user.

In the embodiments of (B) and (C) of FIG. 15, the electronic device 100 may adjust a brightness of the designated region according to a ratio of the designated region to the entire region.

In the embodiments of (B) and (C) of FIG. 15, the electronic device 100 may set a brightness of the designated area when the ratio of the designated region is about 30% of the entire region (in (B) of FIG. 15) to be darker than a brightness of the designated region when the ratio of the designated region is about 80% of the entire region (in (C) of FIG. 15). According to an embodiment of the disclosure, the brightness of the designated region may be adjusted based on the ratio of the designated region to the entire region.

In the embodiment (A) of FIG. 15, a currently-being executed video playback application may be executed with a playback size and location adjusted as in (B) and (C) of FIG. 15 according to a reduced size of the original region as a new region is designated.

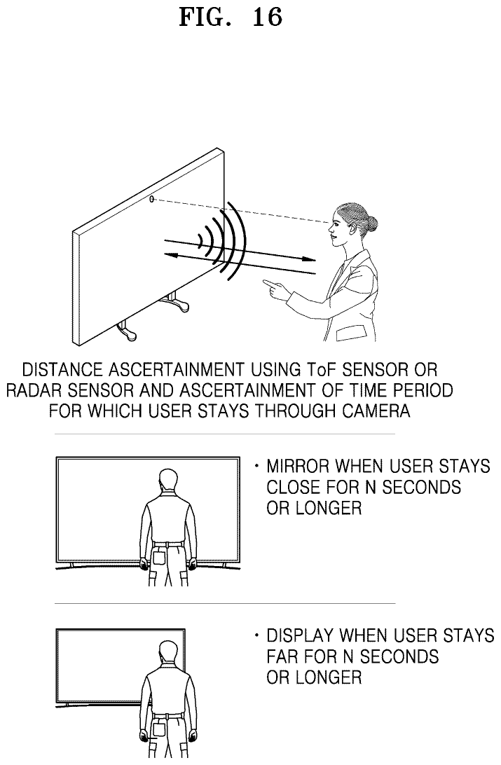

FIG. 16 is a view illustrating an operation of an electronic device according to an embodiment of the disclosure.

The electronic device 100 according to an embodiment of the disclosure may adjust the mode of the display 320 according to a distance between the display 320 and a user.

The electronic device 100 according to an embodiment of the disclosure may detect the distance between the display 320 and the user and a time period for which the user stays within a predetermined distance from the display 320, by using a distance sensor including a radar sensor and a Time-of-Flight (ToF) sensor, an image sensor including a camera, an infrared sensor, and the like.

The electronic device 100 according to an embodiment of the disclosure may automatically set the display 320 to a mirror mode, when the user is detected within a predetermined distance from the display 320.

The electronic device 100 according to an embodiment of the disclosure may set the display 320 to a display mode, when the user is not detected within a predetermined distance from the display 320.

The electronic device 100 according to an embodiment of the disclosure may set the display 320 to a mirror mode when it is detected that the user is within a predetermined distance from the display 320 for a determined time period or longer.

The electronic device 100 according to an embodiment of the disclosure may set the display 320 to a display mode, when the user is not detected as staying within a predetermined distance from the display 320 for a determined time period or longer.

The embodiment of FIG. 16 may be an embodiment in which the electronic device 100 is a medium-sized or large-sized device rather than a portable device such as a smart TV.

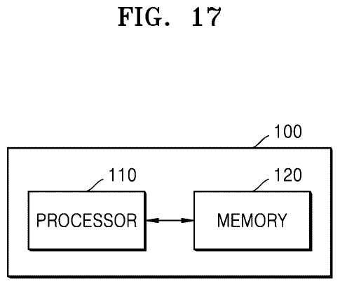

FIG. 17 is a block diagram of an electronic device according to an embodiment of the present disclosure.

Referring to FIG. 17, the electronic device 100 may include the processor 110 and the memory 120.

The memory 120 may store a program for processing and controlling by the processor 110. The memory 120 may store data that is input to the electronic device 100 or output from the electronic device 100.

The memory 120 may include at least one selected from an internal memory (not shown) and an external memory (not shown).

The memory 120 may include at least one type of storage medium selected from among a flash memory type, a hard disk type, a multimedia card micro type, a card type memory (for example, a secure digital (SD) or extreme digital (XD) memory), a random access memory (RAM), a static random access memory (SRAM), a read-only memory (ROM), an electrically erasable programmable ROM (EEPROM), a programmable ROM (PROM), magnetic memory, a magnetic disk, and an optical disk.

The internal memory may include, for example, at least one selected from volatile memory (for example, dynamic RAM (DRAM), static RAM (SRAM), or synchronous dynamic RAM (SDRAM)), non-volatile memory (for example, one time programmable ROM (OTPROM), programmable ROM (PROM), erasable and programmable ROM (EPROM), electrically erasable and programmable ROM (EEPROM), mask ROM, or flash ROM), a hard disk drive (HDD), and a solid state drive (SSD).

According to an embodiment of the disclosure, the processor 110 may load a command or data received from at least one of the non-volatile memory or another element into the volatile memory and process the command or the data. The processor 110 may store data received or generated from another element in the non-volatile memory.

The external memory may include, for example, at least one selected from Compact Flash (CF), Secure Digital (SD), Micro-SD, Mini-SD, extreme Digital (xD) and Memory Stick.

The memory 120 may store one or more instructions executable by the processor 110.

According to an embodiment of the disclosure, the memory 120 may store one or more instructions executable by the processor 110 separately in a plurality of memories 120.

According to an embodiment of the disclosure, the memory 120 may store one or more instructions individually or collectively executable by one or more processors 110.

According to an embodiment, the memory 120 may store various types of information than are received through an input/output interface (not shown).

According to an embodiment of the disclosure, at least one of instructions, an algorithm, a data structure, program code, or an application program readable by the processor 110 may be stored in the memory 120. The instructions, algorithm, data structure, and program code stored in the memory 120 may be implemented in, for example, programming or scripting languages such as C, C++, Java, assembler, and the like.

According to an embodiment of the disclosure, the memory 120 may store instructions for receiving a user input for designating a region on the display 320, predicting a user's intention for designating the region, based on at least one of a location of the region, a size of the region, a usage status of the display 320, or a surrounding environment of the display 320, and controlling the processor 110 to set the region to a mirror mode or a display mode according to the predicted user's intention.

When there is an input of a user or stored preset conditions are satisfied, the processor 110 may execute an operating system (OS) and various applications that are stored in the memory 120.

The processor 110 may include random-access memory (RAM) that stores a signal or data input by an external source of the electronic device 100 or is used as a memory area for various operations performed by the electronic device 100, and read-only memory (ROM) that stores a control program for controlling the electronic device 100.

The processor 110 may include various types of processing circuitry.

The processor 110 may include a single core, a dual core, a triple core, a quad core, or a multiple core thereof. The processor 110 may include a plurality of processors. For example, the processor 110 may be implemented by using a main processor and a sub-processor operating in a sleep mode.

The processor 110 may include at least one of a central processing unit (CPU), a graphics processing unit (GPU), or a video processing unit (VPU). Alternatively, according to embodiments, the processor 110 may be implemented in the form of a system on chip (SOC) that integrates at least one of a CPU, a GPU, or a VPU.

The processor 110 may include various types of processing circuitry and/or a plurality of processors. For example, the term “processor” used herein, and also in the claims, may include various types of processing circuitry, including at least one processor. One or more processors in the at least one processor may be configured to individually and/or collectively perform the various functions described herein, in a distributed manner. As used herein, “a processor”, “at least one processor”, and “one or more processors” may be configured to perform several functions. However, these terms cover, for example, but not limited to, a situation where one processor performs some of the functions and other processor(s) perform others of the functions, and a situation where a single processor is capable of performing all of the functions. In addition, the at least one processor may include a combination of processors that perform various functions of the functions disclosed in a distributed manner. The at least one processor may execute program instructions in order to accomplish or perform various functions.

The processor 110 may control the components of various electronic devices 100 by executing the one or more programs stored in the memory 120.

According to an embodiment of the disclosure, the processor 110 may receive a user input for designating a region on the display 320, predict a user's intention for designating the region, based on at least one of a location of the region, a size of the region, a usage status of the display 320, or a surrounding environment of the display 320, and set the region to a mirror mode or a display mode according to the predicted user's intention.

According to an embodiment of the disclosure, when the region includes a camera lens and the size of the region is equal to or greater than 50% of the area of the display 320, the processor 110 may set the region as a display mode and execute a camera application on the region.

According to an embodiment of the disclosure, when a display mode is set and thus a region is designated in at least a portion of a display currently executing a first application, and the size of the region is less than 50% of the area of the display currently executing the first application, the processor 110 may execute a UI related to the first application on the region.

According to an embodiment of the disclosure, when there is a physical input unit of a display adjacent to or included in the region, the processor 110 may set the region to a display mode and execute a UI related to the physical input unit on the region.

According to an embodiment of the disclosure, the processor 110 may set the region as a mirror mode when the region is designated in at least a portion of the display set as a display mode, and may set the region as a display mode when the region is designated in at least a portion of the display set as a mirror mode.

According to an embodiment of the disclosure, the processor 110 may identify a region on the display where the user's face is reflected. When the designated region includes the region where the user's face is reflected, the processor 110 may set the designated region to a mirror mode, and, when the designated region does not include the region where the user's face is reflected, may set the designated region to a display mode.

According to an embodiment of the disclosure, the processor 110 may adjust a brightness change rate of the display changes, according to a rate of a user input of designating a region, by executing one or more instructions.

According to an embodiment of the disclosure, the processor 110 may detect a trigger and identify entry into a region designation mode, by executing the one or more instructions.

The trigger may include at least one of gesture recognition including a depth long press, voice recognition, or predetermined touch recognition.

FIG. 18 is a detailed block diagram of an electronic device according to an embodiment of the disclosure.

Referring to FIG. 18, the electronic device 100 may include a tuner 340, a processor 110, a display 320, a communication interface 350, a sensor 360, an input/output (I/O) interface 370, a video processor 380, an audio processor 385, an audio output interface 390, memory 120, and a power supply 395.

Hereinafter, components and operations that are the same as those described above with reference to FIG. 17 are given the same reference numerals, and redundant descriptions thereof will be omitted.

The processor 110 of FIG. 18 corresponds to the processor 110 of FIG. 17, and the memory 120 of FIG. 18 corresponds to the memory 120 of FIG. 17. Descriptions of FIG. 14 that are the same as given above will not be repeated herein.

The communication interface 350 according to an embodiment of the disclosure may include a Wi-Fi module, a Bluetooth module, an infrared communication module, a wireless communication module, a LAN module, an Ethernet module, a wired communication module, and the like. Each of these communication modules may be implemented in the form of at least one hardware chip.

The Wi-Fi module and the Bluetooth module may perform communication according to a Wi-Fi method and a Bluetooth method, respectively. When using a Wi-Fi module or a Bluetooth module, the communication interface 350 may first transmit or receive various types of connection information, such as a service set ID (SSID) and a session key, connect with various external devices by using the various types of connection information, and then transmit or receive various pieces of information. The wireless communication module may include at least one communication chip that performs communication according to various wireless communication standards, such as Zigbee, 3^{rd} Generation (3G), 3^{rd} Generation Partnership Project (3GPP), Long Term Evolution (LTE), LTE Advanced (LTE-A), 4^{th} Generation (4G), and 5^{th} Generation (5G).

The communication interface 350 according to an embodiment of the disclosure may receive a user input from an external device.

The communication interface 350 according to an embodiment of the disclosure may communicate with the external device, such as a server.

The communication interface 350 according to an embodiment of the disclosure may include a communication interface that performs wireless communication with a server, etc., such as Bluetooth (BT), and a communication interface that is connected to an external device through an HDMI port, etc. In this case, the communication interface that performs wireless communication with the server, etc., such as BT, may perform connection with other devices and transmission of video/audio data. The communication section that is connected to an external device through an HDMI port, etc., may include not only an input port for receiving an input, but also an output port, such as a DP, an HDMI, an RGB, a DVI, or Thunderbolt, for transmitting a video or audio signal to an external display or a speaker.

The tuner 340 according to an embodiment of the disclosure may tune and select only a frequency of a channel which the electronic device 100 wants to receive from among many radio wave components via amplification, mixing, resonance, or the like of a wired or wireless broadcasting signal. The broadcasting signal includes audio, video, and additional information (for example, an electronic program guide (EPG)).

The tuner 340 may receive a broadcasting signal from various sources, such as terrestrial broadcasting, cable broadcasting, satellite broadcasting, and Internet broadcasting. The tuner 340 may also receive a broadcasting signal from a source such as analog broadcasting or digital broadcasting.

The sensor 360 may sense a voice of the surroundings of the electronic device 100, an image of the surroundings of the electronic device 100, or an interaction with the surroundings of the electronic device 100, and may include at least one of a microphone 331, a camera 332, or a light receiver 333. The sensor 360 may sense a state of the electronic device 100 or a state of the surrounding of the electronic device 100 and may transmit information corresponding to the sensed state to the processor 110.

The microphone 331 receives an uttered voice of a user and a voice generated from the surrounding of the electronic device 100. The microphone 331 may transform the received voice into an electrical signal and output the electrical signal to the processor 110. The microphone 331 may use various noise removal algorithms in order to remove noise that is generated while receiving an external audio signal.

The camera 332 may obtain an image frame, such as a still image or a moving picture. An image captured via the image sensor may be processed by the processor 110 or a separate image processor (not shown).

The image frame obtained by the camera 332 may be stored in the memory 120 or transmitted to the outside via the communicator 3710. At least two cameras 332 may be included according to embodiments of the electronic device 100.

The light receiver 333 receives an optical signal (including a control signal) from an external remote control device (not shown). The light receiver 333 may receive an optical signal corresponding to a user input (for example, touch, pressing, a touch gesture, a voice, or a motion) from the remote control device (not shown). A control signal may be extracted from the received optical signal under the control by the processor 110. For example, the light receiver 333 may receive a control signal corresponding to a channel up/down button for channel switching from the remote control device (not shown).

The sensor 360 is illustrated as including the microphone 331, the camera 332, and the light receiver 333, but is not limited thereto, and may include at least one selected from a magnetic sensor, an acceleration sensor, a temperature/humidity sensor, an infrared sensor, a gyroscope sensor, a position sensor (e.g., a global positioning system (GPS)), a pressure sensor, a proximity sensor, an RGB sensor, an illuminance sensor, or a Wi-Fi signal receiver. Functions of most of the sensors would be instinctively understood by one of ordinary skill in the art in view of their names and thus detailed descriptions thereof will be omitted herein.

The sensor 360 is illustrated as being included in the electronic device 100, but is not limited thereto, and may be included in a control device that is located independently of the electronic device 100 and communicates with the electronic device 100, such as a remote controller. When the sensor 130 is included in a control device of the electronic device 100, the control device may digitize information sensed by the sensor 130 and transmit the digitized information to the electronic device 100. The control device may communicate with the electronic device 100 via short-range communication including infrared, Wi-Fi, or Bluetooth.

For example, a microphone may be included in the electronic device 100, but may be included in a control device that is located independently of the electronic device 100 and communicates with the electronic device 100, such as a remote controller.

According to an embodiment of the disclosure, when a microphone is included in a remote controller, an analog audio signal may be received through the microphone, and the remote controller may digitize the analog audio signal and transmit the digitized analog audio signal to the electronic device 100, such as a TV. In this case, the remote controller may communicate with the electronic device 100 via short-range communication including infrared, Wi-Fi or Bluetooth.

According to an embodiment of the disclosure, the electronic device 100 may include a plurality of communication interfaces 350 capable of various short-range communications including infrared, Wi-Fi, or Bluetooth.

According to an embodiment of the disclosure, the electronic device 100 may include a plurality of communication interfaces 350 in which a communication interface communicating with the server and a communication interface communicating with a remote controller are different from each other. For example, the communication interface that communicates with the server may be a communication interface that uses an Ethernet modem, a Wi-Fi module, or the like, while the communication interface that communicates with a remote controller may be a communication interface that uses a BT module.

According to an embodiment of the disclosure, the electronic device 100 may include a communication interface 350 in which a communication interface communicating with the server and a communication interface communicating with a remote controller are the same as each other. For example, the communication interface that communicates with the server and the communication interface that communicates with the remote controller may be both communication interfaces that use a Wi-Fi module.

According to an embodiment of the disclosure, a device, such as a smartphone, in which a remote control application is provided may perform the same role as the aforementioned remote controller. In other words, the device in which a remote control application is provided may control the electronic device 100, and may perform a voice recognition function.

The device in which a remote control application may be provided may be any device capable of providing and operating an application, such as an AI speaker, other than a smartphone.

According to an embodiment of the disclosure, the device in which a remote control application is provided may perform user voice reception.

According to an embodiment of the disclosure, the electronic device 100 may transmit and receive data to and from the device on which the remote controller or remote control application may be provided, by using Wi-Fi, BT, infrared, or the like, and may include a plurality of communication interfaces capable of implementing the above-described communication method so that the device on which the remote controller or the remote control application may be provided may be controlled.

The I/O interface 370 receives video (for example, a moving picture), audio (for example, a voice or music), and additional information (for example, an EPG) from outside the electronic device 100 under the control by the processor 110. The I/O interface 370 may include a High-Definition Multimedia Interface (HDMI), a Mobile High-Definition Link (MHL), a Universal Serial Bus (USB), a Display Port (DP), a Thunderbolt, a Video Graphics Array (VGA) port, an RGB port, a D-subminiature (D-SUB), a Digital Visual Interface (DVI), a component jack, or a PC port.

The video processor 380 processes video data that is received by the electronic device 100. The video processor 380 may perform a variety of image processing, such as decoding, scaling, noise cancelling, frame rate transformation, and resolution transformation, on the received video data.

The display 320 generates a driving signal by converting an image signal, a data signal, an on-screen display (OSD) signal, and a control signal that are processed by the processor 110. The display 320 may be a plasma display panel (PDP), a liquid-crystal display (LCD), an organic light-emitting device (OLED), a flexible display, or a 3-dimensional (3D) display. The display 320 may be configured as a touch screen, and thus may serve as an input device as well as an output device.

The display 320 may output various contents that are input via the communication interface (not shown) or the I/O interface 370, or may output an image stored in the memory 120. The display 320 may also output, to a screen, information input by the user through the I/O interface 370.

The display 320 may include a display panel. The display panel may be a liquid crystal display (LCD) panel or a panel including various illuminators such as a light emitting diode (LED), an organic light emitting diode (OLED), and a cold cathode fluorescent lamp (CCFL). The display panel may include not only a flat display device but also a curved display device having a curvature or a flexible display device capable of adjusting a curvature. The display panel may be a 3D display or an electrophoretic display.

An output resolution of the display panel may be, for example, a high definition (HD), a full HD, an ultra-HD, or a resolution that is clearer than an ultra-HD.

In the embodiment of FIG. 18, the electronic device 100 is illustrated as including a display, but is not limited thereto. The electronic device 100 may be configured to transmit a video/audio signal to a separate display device including a display by being connected to the separate display device via wire/wireless communication.

According to an embodiment of the disclosure, the electronic device 100 may be implemented in a form that operates by being connected to an external display even when the electronic device 100 does not have a display.

For example, the electronic device 100 may be implemented as a type that outputs an image to a separate external display via a video or audio output port, without a display, like an STB or an Apple TV, or with a simple display for notifications, etc.

In this case, the electronic device 100 may include an output port for outputting a video or audio signal to a display. The output port may be of a type capable of transmitting a video signal and an audio signal simultaneously, such as an HDMI, a DP, or a thunderbolt, or may be of a type having separate ports that transmit a video signal and an audio signal separately.

According to an embodiment of the disclosure, the electronic device 100 may transmit a video or audio signal via wired or wireless communication.

The audio processor 385 processes audio data. The audio processor 385 may perform a variety of processing, such as decoding, amplification, or noise cancelling, on the audio data. The audio processor 385 may include a plurality of audio processing modules to process audios corresponding to a plurality of pieces of content.

The audio output interface 390 outputs audio included in a broadcasting signal received via the tuner 340, under a control by the processor 110. The audio output interface 390 may output audio (for example, a voice or a sound) that is input via the communication interface 350 or the I/O interface 370. The audio output interface 390 may also output audio stored in the memory 120 under a control by the processor 110. The audio output interface 390 may include at least one of a speaker, a headphone output port, or a Sony/Philips Digital Interface (S/PDIF) output port.

The power supply 395 supplies power that is input from an external power source, to the internal components of the electronic device 100, under the control of the processor 110. The power supply 395 may also supply power that is output by one or more batteries (not shown) located in the electronic device 100, to the internal components of the electronic device 100, under the control by the processor 110.

The memory 120 may store various data, programs, or applications for driving and controlling the electronic device 100 under a control by the processor 110. The memory 120 may include a broadcasting receiving module, a channel control module, a volume control module, a communication control module, a voice recognition module, a motion recognition module, a light receiving module, a display control module, an audio control module, an external input control module, a power control module, a power control module of a wirelessly (for example, Bluetooth) connected external device, a voice database (DB), or a motion DB, which are not shown. These modules and the DBs of the memory 120, which are not shown, may be implemented as software in order to perform a broadcasting reception control function, a channel control function, a volume control function, a communication control function, a voice recognition function, a motion recognition function, a light receiving control function, a display control function, an audio control function, an external input control function, a power control function, or a power control function of the wirelessly (for example, Bluetooth) connected external device in the electronic device 100. The processor 110 may perform these functions by using the software stored in the memory 120.

The processor 110 is illustrated as a single element in FIG. 18, but embodiments of the disclosure are not limited thereto. According to an embodiment of the disclosure, the processor 110 may be provided as one or in plurality.

According to an embodiment of the disclosure, the processor 110 may be configured as a dedicated hardware chip that performs artificial intelligence (AI) learning.

A module included in the memory 120 denotes a unit processing a function or operation performed by the processor 110, and may be implemented as software, such as instructions, algorithm, data structure, or program code.

The block diagrams of the electronic device 100 shown in FIGS. 17 and 18 are only exemplary embodiments. Components illustrated in FIGS. 17 and 18 may be combined or omitted according to the specifications of the electronic device 100 when being actually implemented, or additional components may be included in the block diagrams of FIGS. 17 and 18. In other words, two or more components may be combined into a single component, or a single component may be divided into two or more components. A function performed in each block is merely an example to explain embodiments, and a detailed operation or device of each block does not limit the scope of the embodiments.

An operating method of the electronic device 100 according to an embodiment of the disclosure can be embodied as a computer-readable recording medium including instruction codes executable by a computer such as a program module executed by the computer. Computer-readable recording media may be any available media accessible by a computer and includes both volatile and nonvolatile media and removable and non-removable media. The computer-readable recording medium may include program commands, data files, data structures, and the like separately or in combinations. The program commands to be recorded on the medium may be specially designed and configured for the present disclosure or may be well-known to and usable by one of ordinary skill in the art of computer software. Examples of the computer-readable recording medium include a magnetic medium such as a hard disk, a floppy disk, or a magnetic tape, an optical medium such as a compact disk-read-only memory (CD-ROM) or a digital versatile disk (DVD), a magneto-optical medium such as a floptical disk, and a hardware device specially configured to store and execute program commands such as a ROM, a random-access memory (RAM), or a flash memory. Examples of the program commands may include advanced language codes that can be executed by a computer by using an interpreter or the like as well as machine language codes made by a compiler.

According to an embodiment of the disclosure, methods according to various disclosed embodiments may be provided by being included in a computer program product. The computer program product, which is a commodity, may be traded between sellers and buyers. Computer program products are distributed in the form of device-readable storage media (e.g., compact disc read only memory (CD-ROM)), or may be distributed (e.g., downloaded or uploaded) through an application store or between two user devices (e.g., smartphones) directly and online. In the case of online distribution, at least a portion of the computer program product (e.g., a downloadable app) may be stored at least temporarily in a device-readable storage medium, such as memory of a manufacturer's server, a server of an application store, or a relay server, or may be temporarily generated.

Although the examples of the disclosure have been disclosed for illustrative purposes, one of ordinary skill in the art will appreciate that diverse variations and modifications are possible, without departing from the spirit and scope of the disclosure. Thus, the above embodiments should be understood not to be restrictive but to be illustrative, in all aspects. For example, each component described as a single type may be implemented in a distributed manner, and similarly, components described as being distributed may be implemented in a combined form.

An electronic device according to an embodiment of the disclosure may include at least one processor including processing circuitry, and memory storing one or more instructions, wherein, when the one or more instructions are individually or collectively executed by the at least one processor, the electronic device may receive a user input of designating a region on a display, and control the region to operate in a mirror mode or a display mode, based on at least one of a location of a region designated based on the user input, a size of the region, an operation mode of the display, or a surrounding environment of the display.

When the one or more instructions are individually or collectively executed by the at least one processor, the electronic device, when the designated region includes a sensor and a size of the designated region is greater than or equal to a first threshold value of an area of the display, may set the designated region to the display mode and execute an application related to the sensor on the designated region.

When the one or more instructions are individually or collectively executed by the at least one processor, the electronic device, when the display mode is set and the region is designated on at least a portion on the display currently executing a first application, may display a user interface related to the first application on the designated region.

When the one or more instructions are individually or collectively executed by the at least one processor, the electronic device, when a physical input unit or sensor of the display adjacent to the designated region or included in the designated region exists and the size of the designated region is less than a second threshold value of the area of the display, may set the designated region as the display mode and display a user interface related to the physical input unit or the sensor on the designated region.

When the one or more instructions are individually or collectively executed by the at least one processor, the electronic device, when the region is designated on at least a portion of the display while the display is operating in the display mode, may control the designated region to operate in a mirror mode, and, when the region is designated on at least a portion of the display while the display is operating in the mirror mode, may control the designated region to operate in a display mode.

When the one or more instructions are individually or collectively executed by the at least one processor, the electronic device may identify a region on the display where a user's face is reflected, control the designated region to operate in a mirror mode, when the designated region includes a region on which the user's face is reflected, and control the designated region to operate in a display mode, when the designated region does not include the region on which the user's face is reflected.

When the one or more instructions are individually or collectively executed by the at least one processor, the electronic device may adjust a brightness change rate of the display according to a rate of the user input of designating the region.

When the one or more instructions are individually or collectively executed by the at least one processor, the electronic device may detect a trigger to identify entry into a user input mode for designating the region, and the trigger may include at least one of gesture recognition including a depth long press, voice recognition, or predetermined touch recognition.

The user input may include a contact input including a touch input, and a non-contact input including a remote device input, a gesture input, and a voice input.

The display may be implemented in the form of a micro-LED mirror capable of adjusting light on a pixel-by-pixel basis.

An operating method of an electronic device, according to an embodiment of the disclosure, may include receiving a user input of designating a region on a display, and controlling the region to operate in a mirror mode or a display mode, based on at least one of a location of a region designated based on the user input, a size of the region, an operation mode of the display, or a surrounding environment of the display.

The controlling of the region to operate in the mirror mode or the display mode may include, when the designated region includes a sensor and a size of the designated region is equal to or greater than a first threshold value of an area of the display, setting the designated region as the display mode and executing an application related to the sensor on the designated region.

The controlling of the region to operate in the mirror mode or the display mode may include, when the display mode is set and the region is designated on at least a portion on the display currently executing a first application, displaying a user interface related to the first application on the designated region.

The controlling of the region to operate in the mirror mode or the display mode may include, when a physical input unit or sensor of the display adjacent to the designated region or included in the designated region exists and the size of the designated region is less than a second threshold value of the area of the display, setting the designated region as the display mode and displaying a user interface related to the physical input unit or the sensor on the designated region.

The controlling of the region to operate in the mirror mode or the display mode may include, when the region is designated on at least a portion of the display while the display is operating in the display mode, controlling the designated region to operate in a mirror mode, and, when the region is designated on at least a portion of the display while the display is operating in the mirror mode, controlling the designated region to operate in a display mode.

The controlling of the region to operate in the mirror mode or the display mode may include identifying a region on the display where a user's face is reflected, controlling the designated region to operate in a mirror mode, when the designated region includes a region on which the user's face is reflected, and controlling the designated region to operate in a display mode, when the designated region does not include the region on which the user's face is reflected.

An operating method of an electronic device may include adjusting a brightness change rate of the display according to a rate of the user input of designating the region.

The operating method of the electronic device may further include detecting a trigger to identify entry into a user input mode for designating the region, and the trigger may include at least one of gesture recognition including a depth long press, voice recognition, or predetermined touch recognition.

The user input may include a contact input including a touch input, and a non-contact input including a remote device input, a gesture input, and a voice input. Provided may be a non-transitory computer-readable recording medium having recorded thereon a computer program, which, when executed by a computer, performs the method of operating an electronic device.

1. An electronic device comprising:
at least one processor including processing circuitry; and
a memory configured to store one or more instructions executable by the at least one processor,
wherein the at least one processor executes the one or more instructions, individually or collectively, to cause the electronic device to:
receive a user input of designating a region on a display,
identify the region within the display for control, and
control the region to operate in a mirror mode or a display mode based on at least one of a location of the region, a size of the region, an operation mode of the display, or a surrounding environment of the display.

2. The electronic device of claim 1 wherein the at least one processor is further configured to:
based on the region including a sensor and based on the size of the region being greater than or equal to a threshold value of an area of the display, set the region to the display mode; and
execute an application related to the sensor on the region.

3. The electronic device of claim 1, wherein the at least one processor is further configured to, based on the display mode being set and based on the region being designated on at least a portion on the display currently executing an application, display a user interface related to the application on the region.

4. The electronic device of claim 1, wherein the at least one processor is further configured to:
based on a physical input unit or sensor of the display adjacent to the region or included in the region existing and based on the size of the region being less than a threshold value of an area of the display, set the region to the display mode; and
display a user interface related to the physical input unit or the sensor on the region.

5. The electronic device of claim 1, wherein the at least one processor is further configured to:
based on the region being designated on at least a portion of the display while the display is operating in the display mode, control the region to operate in the mirror mode; and
based on the region being designated on at least a portion of the display while the display is operating in the mirror mode, control the region to operate in the display mode.

6. The electronic device of claim 1, wherein the at least one processor is further configured to:
the region identified within the display is where a user's face is reflected;
based on the region including the region on which the user's face is reflected, control the region to operate in the mirror mode; and
based on the region not including the region on which the user's face is reflected, control the region to operate in the display mode.

7. The electronic device of claim 1, the at least one processor is further configured to adjust a brightness change rate of the display according to a rate of the user input of designating the region.

8. The electronic device of claim 1, the at least one processor is further configured to:
detect a trigger to identify entry into a user input mode for designating the region; and
the trigger includes at least one of gesture recognition including a depth long press, voice recognition or predetermined touch recognition.

9. The electronic device of claim 1, wherein the user input further comprises:
a contact input including a touch input; and
a non-contact input including a remote device input, a gesture input, and a voice input.

10. The electronic device of claim 1, wherein the electronic device further comprises the display including a form of a micro-light-emitting diode (micro-LED) mirror capable of adjusting light on a pixel-by-pixel basis.

11. A method of operating an electronic device, the method comprising:
receiving a user input of designating a region on a display;
identifying the region within the display for control; and
controlling the region to operate in a mirror mode or a display mode based on at least one of a location of the region, a size of the region, an operation mode of the display or a surrounding environment of the display.

12. The method of claim 11, wherein the controlling of the region to operate in the mirror mode or the display mode further comprises, based on the region including a sensor and based on the size of the region being greater than or equal to a first threshold value of an area of the display, setting the region to the display mode; and
executing an application related to the sensor on the region.

13. The method of claim 11, wherein the controlling of the region to operate in the mirror mode or the display mode further comprises, based on the display mode being set and the region being designated on at least a portion on the display currently executing a first application, displaying a user interface related to the first application on the region.

14. The method of claim 11, wherein the controlling of the region to operate in the mirror mode or the display mode further comprises:
based on a physical input unit or sensor of the display adjacent to the region or included in the region existing and based on the size of the region being less than a second threshold value of an area of the display, setting the region to the display mode; and
displaying a user interface related to the physical input unit or the sensor on the region.

15. The method of claim 11, wherein the controlling of the region to operate in the mirror mode or the display mode further comprises:
based on the region being designated on at least a portion of the display while the display is operating in the display mode, controlling the region to operate in the mirror mode; and
based on the region being designated on at least a portion of the display while the display is operating in the mirror mode, controlling the region to operate in the display mode.

16. The method of claim 11, wherein the controlling of the region to operate in the mirror mode or the display mode further comprises:
the region identified within the display where a user's face is reflected;
based on the region including the region on which the user's face is reflected, controlling the region to operate in the mirror mode, and;
based on the region not including the region on which the user's face is reflected, controlling the region to operate in the display mode.

17. The method of claim 11, further comprising adjusting a brightness change rate of the display according to a rate of the user input of designating the region.

18. The method of claim 11, further comprising detecting a trigger to identify entry into a user input mode for designating the region,
wherein the trigger includes at least one of gesture recognition including a depth long press, voice recognition or predetermined touch recognition.

19. The method of claim 11, wherein the user input further comprises:
a contact input including a touch input; and
a non-contact input including a remote device input, a gesture input, and a voice input.

20. A non-transitory computer-readable recording medium having recorded thereon a computer program, which is executable by a computer, to perform the method of claim 11.
